(19) United States
(12) Patent Application Publication
(10) Pub. No.: US 2009/0187683 A1
(43) Pub. Date: Jul. 23, 2009

(54) ADAPTIVE LINK WIDTH CONTROL

(75) Inventors: Etai Adar, Yokneam Ilit (IL); Michael Bar-Joshua, Haifa (IL); Ilya Granovsky, Haifa (IL); Shaul Yifrach, Haifa (IL)

Correspondence Address: FREDERICK W. GIBB, III;Gibb Intellectual Property Law Firm, LLC, 2568-A RIVA ROAD, SUITE 304, ANNAPOLIS, MD, 21401, US

(73) Assignee: INTERNATIONAL BUSINESS MACHINES CORPORATION, ARMONK, NY (US)

(21) Appl. No.: 12/017,735

(22) Filed: Jan. 22, 2008

(51) Int. Cl. G06F 3/00

(52) U.S. Cl. 710/58

(57) ABSTRACT

A communications apparatus uses at least one logical communications link that comprises a plurality of lanes within a computerized hardware device. A data transfer monitor is connected to the logical communications link and measures the real-time data transfer bandwidth of the logical communications link. In addition, a link management unit or link width control unit (comparator) is connected to the lanes and to the data transfer monitor and continually compares the real-time data transfer bandwidth to a predetermined data transfer bandwidth standard. If the real-time data transfer bandwidth is below the predetermined data transfer bandwidth standard, the link management unit is adapted to perform up-configuring of the logical communications link by activating additional lanes up to a maximum number of lanes making up the logical communications link. Conversely, if the real-time data transfer bandwidth is above the predetermined data transfer bandwidth standard, the link management unit is adapted to perform down-configuring the logical communications link by deactivating lanes within the logical communications link. The lanes consume less power when the lanes are deactivated relative to when the lanes are activated, thus the down-configuring reduces power consumption.

### BACKGROUND

1. Field of the Invention

The embodiments of the invention generally relate to a method for adaptive link width control based on real-time link utilization measurements.

2. Description of Related Art

Various protocols are used to transmit packetized data over modern switch-based networks having links. One such protocol, PCI Express (PCIe®) is an increasingly popular I/O protocol based on packetized data transfer over high speed full duplex serial interconnects. PCIe® logos and trademarks are licensed by PCI-SIG members (3855 SW 153rd Drive, Beaverton, Oreg. 97006, USA. The analog transceivers responsible for the serial communication are major components of PCIe® port. With technology advances allowing PCIe® speed increases and many PCIe® links being integrated on a single chip, PCIe® analog components (also referred to as HSS—High Speed Serializer/Deserializer) are becoming significant contributors to overall increases in power consumption. Therefore, advance techniques for PCIe® links power management are becoming increasingly important for keeping PCIe® links power low when the link is not fully utilized.

For improved bandwidth, PCI® express combines several physical links into single logical link, resulting in significant bandwidth improvements. PCIe® ports attached to both sides of a logical link determine (during the link negotiation phase) the number of physical links (lanes) forming the logical link.

### SUMMARY

One embodiment herein comprises a communications apparatus used for transferring data. The communications apparatus uses at least one logical communications link that comprises a plurality of lanes within a computerized hardware device, such as a bus or adapter card used within a computerized device, such as a computer. Each of the lanes includes a wire (physical conductor) and analog transmitters and receivers that consume power. The lanes consume less power when the lanes are deactivated relative to when the lanes are activated.

A data transfer monitor is connected to the logical communications link. The data transfer monitor is adapted to measure the real-time data transfer bandwidth of the logical communications link. In addition, a link management unit or link width control unit (comparator) is connected to the lanes and to the data transfer monitor. The comparator is adapted to continually compare the real-time data transfer bandwidth to a predetermined data transfer bandwidth standard.

When the logical communications link is initially activated, the link management unit is adapted to activate all the lanes making up the logical communications link. After being initially activated, if the real-time data transfer bandwidth is close to the predetermined data transfer bandwidth standard, the link management unit is adapted to perform up-configuring of the logical communications link by activating additional lanes up to a maximum number of lanes making up the logical communications link. Conversely, if the real-time data transfer bandwidth is well below the predetermined data transfer bandwidth standard, the link management unit is adapted to perform down-configuring of the logical communications link by deactivating lanes within the logical communications link. As mentioned above, the lanes consume less power when the lanes are deactivated relative to when the lanes are activated, thus the down-configuring reduces power consumption.

The present embodiments are implemented in hardware and do not require specific support from software or the operating system of the computer. The invention proposes an autonomous method for adaptive link width control based on real-time link utilization measurements. The embodiments herein are implemented by hardware state monitoring and do not require software intervention.

These and other aspects of the embodiments of the invention will be better appreciated and understood when considered in conjunction with the following description and the accompanying drawings. It should be understood, however, that the following descriptions, while indicating embodiments of the invention and numerous specific details thereof, are given by way of illustration and not of limitation. Many changes and modifications may be made within the scope of the embodiments of the invention without departing from the spirit thereof, and the embodiments of the invention include all such modifications.

### BRIEF DESCRIPTION OF THE DRAWINGS

The embodiments of the invention will be better understood from the following detailed description with reference to the drawings, in which:

FIG. 1 is a schematic diagram of an embodiment herein; and

FIG. 2 is a flow diagram illustrating an embodiment of the invention.

### DETAILED DESCRIPTION OF EMBODIMENTS

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

As mentioned above, advance techniques for PCIe® links power savings are becoming increasingly important for keeping PCIe® links power consumption low when the link is not fully utilized. The PCIe® standard specifies link recovery sequences that generally occur when the link becomes unreliable and a symbol lock should be re-established. The number of active lanes forming the logical link may be changed during such link recovery.

For example, U.S. Pat. No. 7,136,953 (the complete disclosure of which is incorporated herein by reference) proposes usage of the link recovery mechanism for link bandwidth re-negotiation based on application needs to optimize power consumption. However, such a process of link width selection remains static and requires software and operating system support and extensive knowledge of the hardware infrastructure. With such a method, a runtime application needs to determine the desirable link width. Many applications are not able to utilize such static link width selection due to the inability to determine the correct link requirements, or due to the lack of software support.

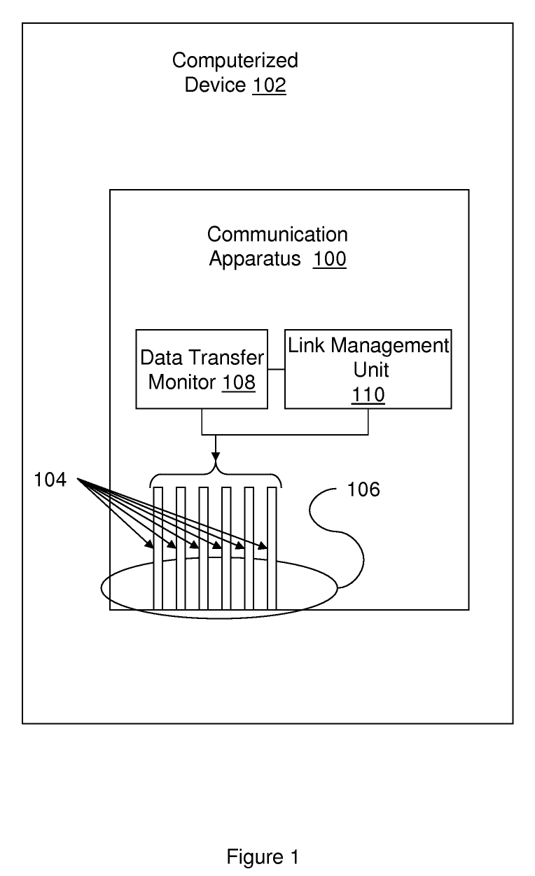

In view of the foregoing, this disclosure describes a method and apparatus for adaptive link width selection that allows optimal resources and power utilization with minimal impact on system performance. For example, as shown in FIG. 1, one embodiment herein comprises a communications apparatus 100 used for transferring data within a computerized hardware device 102, such as a computer 102. The communication apparatus 100 can be any device useful to the computer 102, such as a bus or adapter card. The communications apparatus 100 uses at least one logical communications link 106 that comprises a plurality of lanes 104. Each of the lanes 104 includes a wire (physical conductor) and analog transmitters and receivers that consume power. The lanes 104 consume less power when the lanes 104 are deactivated relative to when the lanes 104 are activated.

A data transfer monitor 108 is connected to the logical communications link 106. The data transfer monitor 108 is adapted to measure the real-time data transfer bandwidth (rate of data units communicated per unit of time) of the logical communications link 106. In addition, a link management unit or link width control unit (comparator) 110 is connected to the lanes 104 and to the data transfer monitor 108. The link management unit 110 is adapted to continually compare the real-time data transfer bandwidth to a predetermined data transfer bandwidth standard.

Computerized devices are discussed above and such computerized devices that include chip-based central processing units (CPU's), input/output devices (including graphic user interfaces (GUI), memories, link management units, processors, etc. are well-known and readily available devices produced by manufactures such as International Business Machines Corporation, Armonk N.Y., USA. Such computerized devices commonly include link management units, data transfer monitors, input/output devices, power supplies, processors, electronic storage memories, wiring, etc., the details of which are omitted herefrom to allow the reader to focus on the salient aspects of the embodiments described herein.

When the logical communications link 106 is initially activated, the link management unit 110 is adapted to activate all the lanes 104 making up the logical communications link 106. After being initially activated, if the real-time data transfer bandwidth is close to the predetermined data transfer bandwidth standard (e.g., greater than 60%, 75%, 90% etc., of the bandwidth standard), the link management unit 110 is adapted to perform up-configuring of the logical communications link 106 by activating additional lanes 104 up to a maximum number of lanes 104 making up the logical communications link 106. Conversely, if the real-time data transfer bandwidth is well below the predetermined data transfer bandwidth standard (e.g., less than 40%, 60%, 75%, etc. of the bandwidth standard), the link management unit 110 is adapted to perform down-configuring the logical communications link 106 by deactivating lanes 104 within the logical communications link 106. Those ordinarily skilled in the art would understand that the above percentages are only given as examples, and that any useful percentages could be used to trigger the up and down configuring processes. As mentioned above, the lanes 104 consume less power when the lanes 104 are deactivated relative to when the lanes 104 are activated, thus the down-configuring reduces power consumption. Also, as mentioned above, the PCIe® standard specifies link recovery sequences that generally occur when the link becomes unreliable and a symbol lock should be re-established. The number of active lanes forming the logical link may be changed during such link recovery.

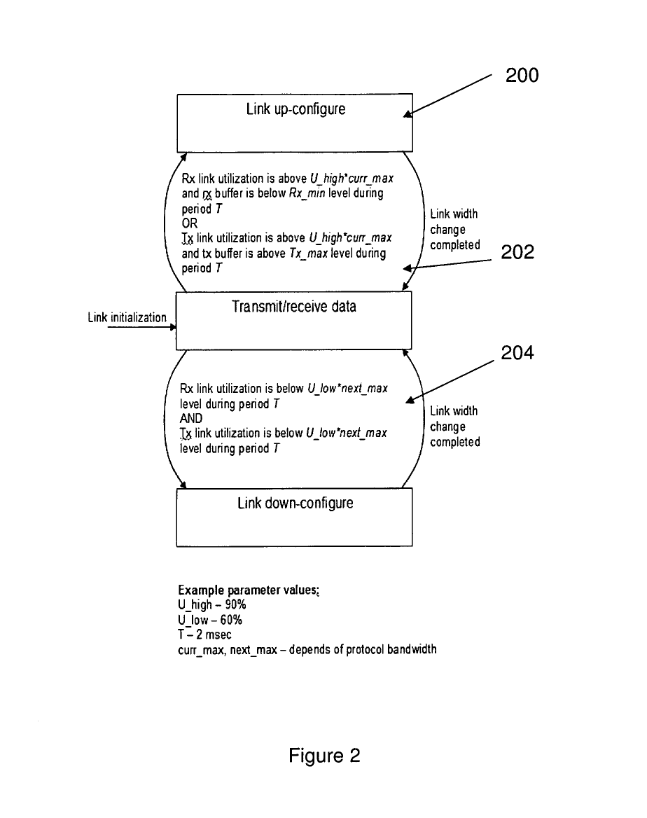

FIG. 2 is a flow diagram illustrating the invention that shows the relationship between the transmitted/received data 202, the link up-configure process 200, and the link down-configure process. The embodiments herein are based on constant monitoring of link bandwidth utilization after initial link training. If link utilization of the transmit/receive data 200 drops below certain threshold point (e.g. 60% of the next lower width bandwidth) for certain time period, link width renegotiation to lower width (down-configure 204) is triggered. If link utilization remains at a high level for certain time period (e.g. 90% of the current width bandwidth) while the application buffer state indicates that additional bandwidth would be required (transmit buffers over-utilized or receive buffers underutilized) link width negotiation to higher width (up-configure 200) is triggered.

Initially, the invention forms a logical link based on the maximal possible number of lanes provided by devices attached to the link. After the link becomes operational, the monitor 108 monitors the actual data transfer bandwidth. Whenever the data transfer bandwidth is reduced to the point where a lower number of lanes could provide sufficient bandwidth (based on a predetermined percentage or transfer rate) the embodiments herein trigger link recovery while disabling unneeded lanes (down-configure 204). This will cause the link to come up with fewer active lanes, resulting in lower power consumption for the same actual data transfer bandwidth. When the link becomes backed up due to insufficient bandwidth (based on a predetermined percentage or transfer rate) the embodiments herein trigger link recovery with additional lanes enabled, so that the link will come up in wider configuration (up-configure 200). Similar approaches can be used for link speed up-configure/down-configure whenever a protocol provides multiple speed supports.

Some implementations allow programming control over the threshold levels that trigger link up or down-configure. Threshold levels may vary between different applications, as sensitivity levels should be directly linked to link width change negotiation and its impact on the active traffic.

Thus, as discussed above, PCIe® link can include several physical wires (lanes) forming together a single logical link. As also noted above, the analog transmitters/receivers that are part of the lanes and links are significant contributors to the overall power consumption. PCIe® link is formed by an initial detection of the number of lanes implemented on both sides on the link. Conventionally, this initially established link width does not change, even if not all the link bandwidth is utilized for data transfer. This results in excessive power consumption by digital and analog circuits. To the contrary, the embodiments herein dynamically deactivate and activate the lanes within the link to only use the number of lanes that are necessary to maintain a certain bandwidth level. By deactivating some of the links at certain times, the embodiments herein save power.

The embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of embodiments, those skilled in the art will recognize that the embodiments of the invention can be practiced with modification within the spirit and scope of the appended claims.

What is claimed is:

1. A communications apparatus comprising:
a logical communications link comprising a plurality of lanes within a computerized hardware device, wherein each of said lanes comprises a physical conductor;
a data transfer monitor connected to said logical communications link, wherein said data transfer monitor is adapted to measure a real-time data transfer bandwidth of said logical communications link;
a link management unit connected to said lanes and to said data transfer monitor, wherein said link management unit is adapted to continually compare said real-time data transfer bandwidth to percentages of a predetermined data transfer bandwidth standard,
wherein if said real-time data transfer bandwidth is above a first percentage of said predetermined data transfer bandwidth standard, said link management unit is adapted to perform up-configuring of said logical communications link by activating additional lanes up to a maximum number of lanes making up said logical communications link, and
wherein if said real-time data transfer bandwidth is below a second percentage of said predetermined data transfer bandwidth standard, said link management unit is adapted to perform down-configuring said logical communications link by deactivating lanes within said logical communications link.

2. The communications apparatus according to claim 1, wherein each of said lanes comprises analog transmitters and receivers that consume power.

3. The communications apparatus according to claim 1, wherein said lanes consume less power when said lanes are deactivated relative to when said lanes are activated, such that said down-configuring reduces power consumption.

4. A communications apparatus comprising:
a logical communications link comprising a plurality of lanes within a computerized hardware device, wherein each of said lanes comprises a physical conductor;
a data transfer monitor connected to said logical communications link, wherein said data transfer monitor is adapted to measure a real-time data transfer bandwidth of said logical communications link;
a link management unit connected to said lanes and to said data transfer monitor, wherein said link management unit is adapted to continually compare said real-time data transfer bandwidth to percentages of a predetermined data transfer bandwidth standard,
wherein, when said logical communications link is initially activated, said link management unit is adapted to activate all said lanes making up said logical communications link,
wherein if said real-time data transfer bandwidth is above a first percentage of said predetermined data transfer bandwidth standard, said link management unit is adapted to perform up-configuring of said logical communications link by activating additional lanes up to a maximum number of lanes making up said logical communications link, and
wherein if said real-time data transfer bandwidth is below a second percentage of said predetermined data transfer bandwidth standard, said link management unit is adapted to perform down-configuring said logical communications link by deactivating lanes within said logical communications link.

5. The communications apparatus according to claim 4, wherein each of said lanes comprises analog transmitters and receivers that consume power.

6. The communications apparatus according to claim 4, wherein said lanes consume less power when said lanes are deactivated relative to when said lanes are activated, such that said down-configuring reduces power consumption.
